(19) United States
(12) Patent Application Publication
(10) Pub. No.: US 2009/0052655 A1
(43) Pub. Date: Feb. 26, 2009

(54) Method for Encryption and Decryption

(76) Inventor: Igor Aleksandrovich Semaev, Nyborg (NO)

Correspondence Address: KILPATRICK STOCKTON LLP, 1001 WEST FOURTH STREET, WINSTON-SALEM, NC, 27101, US

(21) Appl. No.: 11/883,587

(22) PCT Filed: Feb. 6, 2006
(86) PCT No.: PCT/NO06/00050

§ 371 Date: May 22, 2008

(30) Foreign Application Priority Data
Feb. 7, 2005 (NO) 20050646

(51) Int. Cl. H04L 9/28

(52) U.S. Cl. 380/28

(57) ABSTRACT

It is described a method of encrypting digital information in a sender and decrypting said digital information in a receiver, where said sender and receiver agree on a block of a working key. First a sender generates a secret padding code. Said sender combines said digital information with the said secret padding code to produce a block of padded plaintext. Then, said sender computes encrypted information by applying a triangular encryption function. The sender transmits said encrypted information to said receiver, where the receiver decrypts said encrypted information received from said sender by applying a triangular decryption function, and then the receiver unpads said digital information by removing said secret padding code from the blocks of plaintext.

The present invention relates to a method of encrypting digital information in a sender and decrypting said digital information in a receiver, where said sender and receiver agrees on a working key.

### PRIOR ART

Several symmetric encryption methods are known. The simplest and fastest way to encrypt a message is to use a stream cipher. Stream ciphers encrypt plaintext one byte or one bit at a time. The problem with the stream cipher is that for a new plaintext the sender should use a different key sequence than previously, otherwise the key sequence can be discovered by an adversary.

The block cipher is a way to handle the problem of reusing the key sequence. Block ciphers encrypt plaintext in blocks; most commonly are 64 and 128 bits. To apply the block cipher the sender cuts the plaintext into blocks, performs the encryption by using a known method of encryption. With a strong block cipher the key sequence can be reused several times. But a strong block cipher is a complicated matter not only to a cryptanalyst but also to the implementer. In particular, it works more slowly than a stream cipher.

Another common way to reuse said key sequence is to make the cipher be dependent on a public initial vector, which should be transmitted before the cipher text in order for the receiver to be able to decrypt the message correctly. This public initial vector defines the initial state of the cipher, so in some implementations of this idea the cipher may be vulnerable to the chosen public initial vector attack.

In cryptography there is a natural distinction between the level of secrecy of the cipher key and that of a particular plaintext. Generally, the cipher key should be kept more secret than the plaintext because the knowledge of the key leads to getting all plaintexts encrypted with that key. In a randomized encryption scheme the padding code is supposed to be as secret as the plaintext and the encryption function is based on a strong block or public-key cipher. Therefore the knowledge of the padding code for a particular plaintext does not enhance finding the cipher key. The randomized encryption can be considered as a way of using known ciphers, which makes them strong when the set of possible plaintexts is small.

Most of the known symmetric ciphers, like DES or AES, are product or iterated ciphers. Their encryption-decryption functions are compositions of a number of rather simple functions. In order to achieve a high level of security the number of terms in the composition (or the number of rounds) should be rather large; usually from 10 to 20. Otherwise some of such ciphers may be vulnerable to algebraic attacks based on effective methods for solving sparse systems of nonlinear equations. Every product or iterated cipher may be described by a sparse system of nonlinear equations, where the degree of sparseness varies from one cipher to another. But increasing the number of rounds obviously results in losing the speed of the encryption-decryption algorithm.

An aim of the present invention is consequently to present a new method for producing a symmetric cipher, which hopefully will give a faster way of encryption and decryption than block ciphers.

Therefore, the encryption-decryption algorithm in the present invention, which is in the base of the triangular cipher, may be simplified so that if the triangular cipher is used as an asynchronous stream cipher the encryption will not be secure. But for the triangular cipher comprising a secret padding code, which is supposed to be as secret as the key, the simplification of an encryption function implies a faster encryption without losing its security.

In opposite to product or iterated ciphers, triangular ciphers are constructed without using compositions of simple functions which depend on small numbers of variables. To encrypt one block of the plaintext a triangular ciphers typically implements one or various modular multiplications of integer numbers of the block size.

Triangular ciphers generally give a faster way of reusing said key sequence.

Similarly to block ciphers, triangular ciphers can work with blocks of information, e.g. 128 bits or more. The strength of the cipher increases as the block size n increases, i.e. the brute force attack takes about 2ⁿ trials.

Triangular ciphers may be used to protect all communications in computer networks. The method is easy to implement, especially in software. Triangular ciphers may be used to provide confidentiality and data integrity, when used as a Message Authentication Code (MAC), in all computer networks including the Internet. They may be particularly useful for banking.

### SHORT DESCRIPTION OF THE INVENTION

The encryption method according to the present invention is based on padding a plaintext with a secret padding code before encryption and using a triangular map as the encryption function. In the triangular cipher method the padding code is as secret as the cipher key so that the knowledge of the secret padding code usually leads to breaking the cipher (finding its key), because a simpler map is taken as the encryption function and, in particular, because of its triangularity. Although the encryption function is very simple, this, on the whole, makes the encryption-decryption algorithm work faster without losing its security.

For two parties (sender and receiver) to be able to exchange information they agree on a master key. The sender and receiver then expand said master key to a working key. The working key is then used to encrypt messages in an encryption function and decrypt messages in a decryption function.

The encryption function can also be made to depend on a public initial vector (IV), which may change from one message to another. Therefore said vector should be transmitted before the ciphertext. In this case it is not necessary for the secret code to change very often.

Another object of the invention is using a triangular cipher as a Message Authentication Code (MAC) along with the encryption. To do so the sender pads the plaintext with a fixed public block at the end and applies the triangular cipher to get a ciphertext. The receiver computes the plaintext from the ciphertext and checks its last block. If it is equal to the fixed public block above, the receiver accepts the integrity and the authenticity of the plaintext, otherwise the receiver rejects it.

The encryption function in the sender constructs the ciphertext from the information of the secret padding code, the plaintext and the working key sequence. The secret padding code can then be discarded if necessary. Subsequently the encrypted message, i.e. the ciphertext, is sent from the sender to the receiver.

To decrypt the plaintext from said received ciphertext the receiver computes the plaintext padded with said secret padding code in the decryption function, given the working key and an initial vector, where an invertibility property of the encryption function is used to determine the plaintext. The secret padding code can now be discarded in the receiver if necessary.

One object of the present invention is characterized by the following steps:
a) sender generates a secret padding code x,
b) sender combines said digital information with said secret padding code x to produce a padded plaintext represented by blocks pᵢ,
c) sender computes encrypted information represented by blocks cᵢ, by applying a triangular encryption function g,
d) sender transmits said encrypted information cᵢ to said receiver,
e) receiver decrypts said encrypted information cᵢ received from said sender by applying a triangular decryption function h, comprising the inversion of encryption function g, and
f) receiver unpads said digital information by removing said secret padding code x in b) from the blocks of plaintext pᵢ.

Alternative objects of the present invention are described by the features of claims 2-10.

### SHORT DESCRIPTION OF THE FIGURES

The invention will now be described with reference to the accompanying drawings, wherein:

FIG. 1 shows a block diagram of an example of the encryption process of the present invention.

FIG. 2 shows a block diagram of an example of the decryption process according to FIG. 1 of the present invention.

FIG. 3 shows a block diagram of a further example of the encryption method according to the present invention.

FIG. 4 shows a block diagram of a further example of the decryption method according to FIG. 3 of the present invention.

FIG. 5 shows a block diagram of an example of the function g in FIGS. 3 and 4 according to the present invention.

FIG. 6 shows a block diagram of a further example of another embodiment of the encryption method according to the present invention.

FIG. 7 shows a block diagram of a further example of another embodiment of the decryption method according to FIG. 6 of the present invention.

### DESCRIPTION OF THE INVENTION

### The Triangular Symmetry

Let K, C, X, P be sets, where K denotes a set of keys, P is the set of all possible plaintexts and C is the set of related cipher texts. Let

K=K₀×K₁,

where K₀ is a finite set and k=(k₀,k₁) when kεK. Similarly,

C=C₀×C₁,

where C₀ is an finite set and c=(c₀,c₁) when cεC. Let X be a finite set of secret pads. An encryption function ƒₖ depends on the key kεK and defines the map

ƒₖ:X×P→C (1)

such that a property of triangularity is satisfied. It is claimed that

ƒₖ(x,p)=c or ƒ₍k_{₀}_{,k}_{₁}₎(x,p)=(c₀,c₁), (2)

where xεX, and pεP, and the block c₀ of the cipher text only depends on x and k₀. We denote this fact as

ƒₖ_{₀}(x)=c₀ (3)

and it is claimed that the function ƒₖ_{₀} the restriction of ƒₖ. The function ƒₖ is invertible. This means that given cεC and kεK the unique pair x,p can be found such that formula (2) applies, and given c₀εC₀ and k₀εK₀ the unique x can be found such that formula (3) applies.

Though it is not necessary, it can be assumed that another symmetric property of the invertibility is satisfied. Namely, given any cεC and x,p there is just one kεK such that formula (2) holds and given c₀εC₀ and xεX the unique k₀εK₀ is found such that formula (3) applies.

To encrypt a plaintext the sender represents said plaintext as an element pεP by adding some auxiliary random or fixed bits. Subsequently, said sender produces a secret padding code xεX. Preferably, x should be different for different messages. Thereafter said sender constructs the padded plaintext x,p and computes the ciphertext c by using formula (2), and then he can discard the secret padding code x. In order to decrypt the plaintext from the ciphertext c the receiver computes x,p by using formula (2) and the invertibility of ƒₖ, given the key k. Now the sender can find p. Later the receiver can discard the secret padding code x.

### DETAILED DESCRIPTION OF THE FIGURES

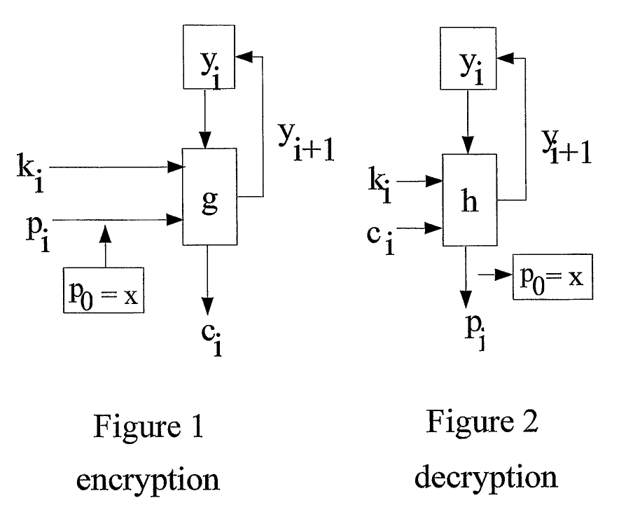

FIG. 1 shows a sender for implementing a general encryption method of the present invention. Let X, Y, C₀ and K₀ be finite sets. Let P=X^{s} for the set of all possible plaintexts, and C=C₀^{s+1} for the set of ciphertexts, and K=K₀^{s+1} for the set of working keys.

Let g be an encryption function:

g(pᵢ,kᵢ,yᵢ)=(cᵢ,yᵢ₊₁)

if and only if h is a decryption function:

h(cᵢ,kᵢ,yᵢ)=(pᵢ,yᵢ₊₁)

for any kᵢεK₀, pᵢεX, yᵢ,yᵢ₊₁εY, cᵢεC₀, and i=1, 2, 3, . . . . The arguments of the functions are represented by binary n-strings for an appropriate n, such as 128 or 256. Here p₀,p₁,p₂ . . . is a padded plaintext, where p₀=x is a secret padding code, and c₀,c₁,c₂ . . . is the related ciphertext and y₀,y₁,y₂ . . . is the sequence of internal states of the cipher, which are hereafter referred to as carriers. The initial state y₀ is a public element and may be used as a public initial vector (IV), and can be produced by a random number generator. The public IV would in this case be sent before the ciphertext.

An alternative method for generating the public IV is for it to be fixed, and it would then be a part of the cipher.

To implement said encryption method said sender and receiver must agree on a master key by using a public key distribution protocol, such as the Diffie-Hellman protocol or its modification, or the master key can be distributed by an authority. Thereafter, the master key is extended to a working key kᵢ. The working key k is an element of K, so k=(k₀,k₁, . . . , kₛ), where kᵢεK₀, which may be reused in order to encrypt several messages. However, working keys used only once will enhance security of the algorithm. Because s may be big, it is convenient to repeat some of the sequences in the working key k in order to not keep in the memory very long working keys. For example, a relatively small number s₀) like s₀=0, 1 or 2 is fixed and let k=(k₀,k₁, . . . , kₛ₀,k₀,k₁, . . . , kₛ₀, . . . ). The method to produce k from the master key k* is flexible. One way is to use a one way function φ:K₀→K₀. For simplicity let k*εK₀, then

k₀=φ(k*) and kᵢ=φ(kᵢ₋₁)

for i=1, . . . , s₀. When s₀>0 the encryption function ƒₖ may be taken simpler without loss in security.

In some implementations it is important to avoid a Side Channel Attack. In this case it is preferable to change blocks of the working key kᵢ from one to another using some simple function, which is not specified herein.

To encrypt the plaintext pεP, where p=(p₁, . . . , pₛ), and pᵢεX the sender produces a secret padding code xεX. Said padding code can be produced in a plurality of ways, and preferably the padding code is precomputed, such as in one of the following methods:
x is an output of a random number generator,
x is a hash-value of the master key and the number of the message the sender is encrypting, or some other information, such as time, receivers name, receivers address, or
x is produced by a mixture of both above-mentioned methods.

Preferably x can be different for different messages. If the same secret padding code is used to encrypt two different plaintexts, the knowledge of one of the plaintexts can reveal some information of the other. Using a good random number generator for producing x can enable encryption up to about 2^{n/2-10} messages for any length with one working key. The probability of coincidence of the secret padding code for two different messages is then negligible.

### Necessary Condition

The following condition for the general triangular cipher must be fulfilled for the encryption to be secure.

Let k=(k₀,k₁) be a working key and for a ciphertext c=(c₀,c₁) let p be the related plaintext. Then for any fixed triple cₒ,k₁,p the block c₁ of the cipher text c is a function only in x. Note that it is assumed the properties of invertibility of the function ƒₖ and its restriction. The set

U(cₒ,k₁,p)={c₁|xεX}

is defined which is a subset of C₁. Let u be the size of U(cₒ,k₁,p). Generally u=u(c₀,k₁,p) is a function in c₀,k₁,p and

u≦min{|C₁|,|X|}.

For each triple c₀,k₁,p the partition is present:

X=X₁∪ . . . ∪Xᵤ (4)

into classes, where x′ and x″ are in the same class if and only if c₁′=c₁″ for the last blocks of related ciphertexts c′,c″ produced from the plaintext p with the secret padding codes x′, x″.

The necessary condition for the cipher to be secure will then be:

For most triples, cₒ,k₁,p, the size of the set U(cₒ,k₁,p) is about min{|C₁|,|X|}.

This condition is also a necessary condition in said decryption method for the cipher to be secure.

The theorem described below will prove that if the above-mentioned condition is violated, the cipher may be insecure. The natural assumption is: Given a number of pairs
p₁, c₁,
p₂, c₂,
. . .
pᵣ, cᵣ
   of plaintexts pᵢ and related cipher texts cᵢ, produced with the same working key k, and a particular ciphertext c is also produced with k, find the true plaintext p for c.

It is assumed that the terms of formula (4) are given explicitly, that is the representatives of the classes are given. Though c₁ depends on k₁ and p, which may be unknown, in practise it is often possible to get them.

### Theorem

Let for any triple cₒ,k₁,p the number u=u(c₀,k₁,p) be bounded by v. Then
1. if

v<|K₁|^{(1-1/r)}
for some natural number r and one knows r pairs of plaintexts, ciphertexts produced with the same working key k=(k₀,k₁), then in

O(rv log v)
steps on the average one computes the true k₁.
2. If the true k₁ and a ciphertext c are known, then in O(v) steps a subset of size no more than v of the set P is computed, which comprises the true plaintext p.

### Proof

1. Let one pair p, c of plaintext, ciphertext be known, where c=(c₀,c₁) is produced with the working key k=(k₀,k₁). For each term Xᵢ of the formula (4) a representative xᵢεXᵢ is taken. Then the padded plaintext xᵢ, p is composed and kᵢ=(kᵢ₀,kᵢ₁) is computed from the equation

c=ƒₖ_{ᵢ}(xᵢ,p) (5)

using the invertibility of ƒ. In the end there is a set of no more than v elements

{kᵢ₁}⊂K₁.

One of these elements is the true k₁. Let the true x be in Xᵢ for some i, where 1≦i≦u and let xᵢ be the chosen above representative of this class. From the definition of formula (4):

(c₀,c₁)=ƒ_{(k′}_{₀}_{,k}_{₁}₎(xᵢ,p)

for some k′₀εK₀. From this equation and formula (5) kᵢ=(k′₀,k₁) and therefore k₁=kᵢ₁.

So having r pairs of plaintexts, ciphertexts, r random looking subsets of size no more than v of the set K₁ are computed, which have the true k₁ as their common element. On the average the number of common elements of such subsets is bounded by

$$\frac{{v}^{r}}{{\vert {K}_{1} \vert}^{( r - 1 )}}$$

When v<|K₁|^{(1-1/r)} this number is less than 1. So on the average there is only one common element, which should be the true k₁. It is computed by using sorting algorithms in O(rv log v) steps.

2. Formula (4) is now considered for the triple cₒ,k₁,p, where p is unknown. For each term Xᵢ of the partition a representative xᵢ is taken. Then kᵢ₀εK₀ is computed from the equation

c₀=ƒₖ_{ᵢ₀}(xᵢ)

by using the invertibility of the restriction of ƒₖ. The working key kᵢ=(kᵢ₀,k₁) is then constructed and a plaintext p₁ᵢ is computed from the equation

c=ƒₖ_{ᵢ}(xᵢ,p₁ᵢ) (6)

At the end a set of elements is computed

{p₁ᵢ}⊂P.

One of them is the true plaintext p. Let the true x be in Xᵢ for some i. Let xᵢ be the chosen above representative of this class. From the definition of Xᵢ

(c₀,c₁)=ƒₖ_{ᵢ}(xᵢ,p).

From this equation and formula (6) we get p=p₁ᵢ.

### Remark 1: Example of Using the Theorem

Let m by any natural number and Z/mⁱ be the set of all residues modulo mⁱ. Z/mⁱ is identified with the set of natural numbers {0, 1, . . . mⁱ−1}. Let:

K₀=X=Z/m, and K₁=P=Z/m^{s}, and C=Z/m^{s+1}

for some natural number s. The padded plaintext x,p is identified with the number pₓ=x+pmεZ/m^{s+1} and for kεK we get k=k₀+k₁m, where k₀εZ/m and k₁εZ/m^{s}.

Let one get the ciphertext c=c₀+c₁m, where c₀εZ/m and c₁εZ/m^{s} by the rule

c≡pₓ+k(mod m^{s+1}). (7)

The necessary condition will be shown as violated for such an encryption function in the following. The formula (7) is rewritten as

c₀≡k₀+x(mod m),

c₁≡k₁+p+s(k₀,x)(mod m^{s}),

where s(k₀,x) is the carrier, so s(k₀,x)=0 or m. It is assumed that kₒ≠0. It implies that

U(c₀,k₁,p)={k₁+p,k₁+p+m}.

It is easy to define the terms of the partition Z/m=X₁∪X₂, that is to find representatives for classes, which are 0 and m−1. Therefore the Theorem shows that such an encryption function is insecure. To clarify this, an application of the algorithm described in the proof of the Theorem is given. For chosen representatives of the classes one gets two possibilities

(0,p)+(k₀,k₁)=(k₀,k₁+p)=(c₀,c₁)

and so k₁≡c₁−p(mod m^{s}), or

(m−1,p)+(k₀,k₁)=(k₀−1,k₁+p+1)=(c₀,c₁)

and so k₁≡c₁−p−1(mod m^{s}). Therefore it is found that

k₁ε{c₁−p,c₁−p−1}.

On the average it is only needed one other pair of plaintext, ciphertext to compute the true k₁. Knowing the true k₁ one finds from the above that

pε{c₁−k₁,c₁−k₁−1}

then the true p is found using a criterion for the plaintext if there is any.

FIG. 2 shows a receiver for implementing a general decryption method of the present invention. The decryption function h is the function relating to the encryption function g in FIG. 1.

The similar cryptanalysis is applied to the cipher represented in FIGS. 1 and 2. For simplicity it is assumed that given any c₀εC₀, xεX, and yεY there exists only one k₀εK₀ so that

g(x,k₀,y)=(c₀,y₁) (8)

for some y₁εY.

For any fixed yεY and c₀εC₀ the formula (8) defines a map X→Y such that x→y₁. It is claimed that this map should be injective or close to that. Otherwise a method similar to that presented in the proof of the Theorem can be used to find (k₁,k₂ . . . ), which is the part of the working key. By similar reasons another two maps should be injective or close to that. They are: upon fixing any xεX and k₀εK₀, the formula (8) defines maps Y→C₀ such that y→c₀ and Y→Y such that y→y₁.

Let n be a natural number and m be a prime number such that 2ⁿ⁻¹<m<2ⁿ. To simplify the computation we take m=2ⁿ−t, where t<2^{n/2}−2. Actually a small number for t like 1, 3, 5, . . . can be used. By Vₙ we denote the set of binary n-strings. Let Z/m be the set of residues modulo m, where Z/m is {0, 1, . . . , m−1}. The numbers bεZ/m are represented by binary n-strings as b=(b₀,b₁, . . . , bₙ₋₁), where b=b₀+b₁2+ . . . +bₙ₋₁2ⁿ⁻¹, and Z/m⊂Vₙ.

### EMBODIMENT 1

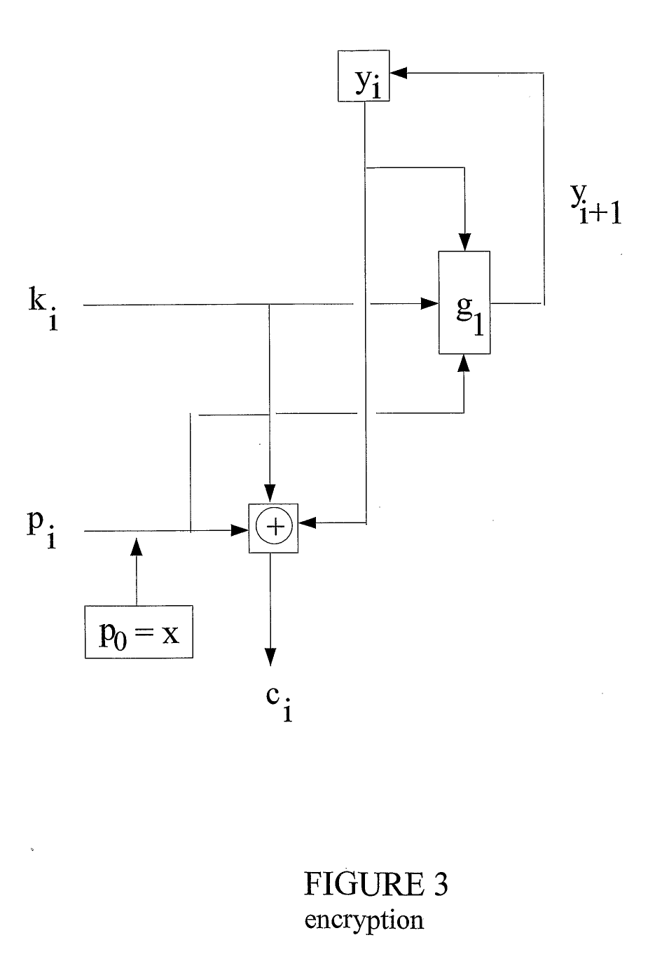

FIG. 3 shows an exemplary embodiment of the encryption function g of the encryption method for the sender in FIG. 1. A first pair is defined: X=Y=C₀=K₀=Vₙ and the encryption function g: Vₙ×Vₙ×Vₙ→Vₙ×Vₙ is defined by: g(pᵢ,kᵢ,yᵢ)=(pᵢ⊕ kᵢ⊕ yᵢ,g₁(pᵢ,kᵢ,yᵢ))

where yᵢ₊₁=g₁(pᵢ,kᵢ,yᵢ) is the carrier function so that the ciphertext cᵢ=pᵢ⊕ kᵢ⊕ yᵢ can be calculated. Here ⊕ denotes an XOR of binary strings in Vₙ.

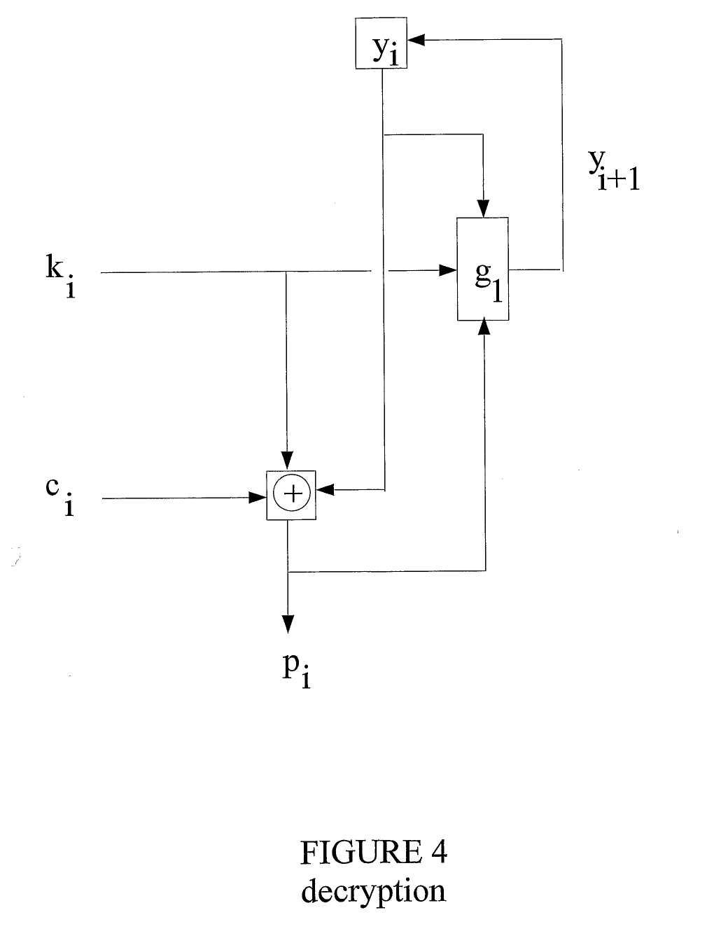

FIG. 4 shows an exemplary embodiment of the decryption function h of the decryption method corresponding to the encryption method described in FIG. 3.

The general function h: Vₙ×Vₙ×Vₙ→Vₙ×V_{b} is defined by: h(cᵢ,kᵢ,yᵢ)=(cᵢ⊕ kᵢ⊕ yᵢ,g₁(cᵢ⊕ kᵢ⊕ yᵢ,kᵢ,yᵢ))

where yᵢ₊₁=g₁(pᵢ,kᵢ,yᵢ) is identical to the carrier function g₁ in the encryption function so that plaintext pᵢ=cᵢ⊕ kᵢ⊕ yᵢ can be calculated. Also here ⊕ denotes the XOR of binary strings in Vₙ.

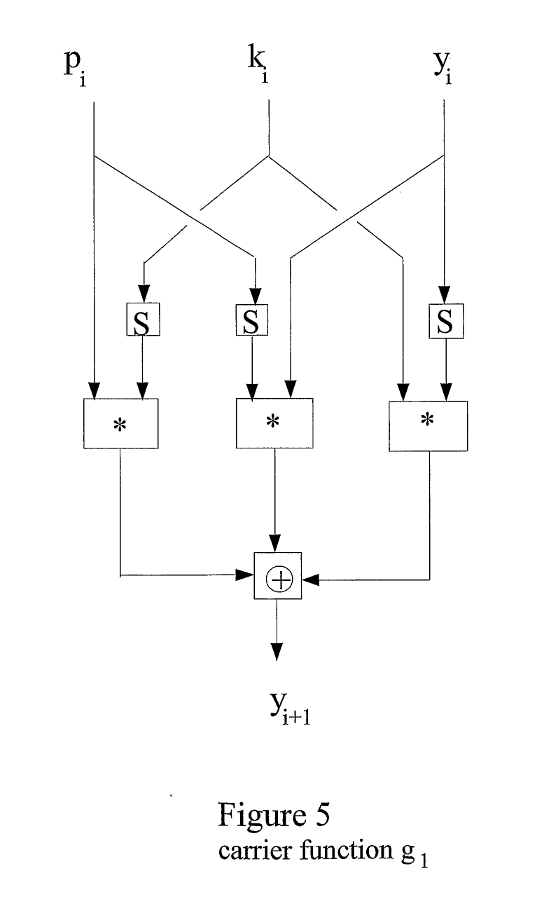

FIG. 5 shows an exemplary implementation of the carrier function g, in FIGS. 3 and 4 of the present invention. For performing the encryption-decryption algorithm the carrier function g₁ is implemented by the following formula:

yᵢ₊₁=g₁(pᵢ,kᵢ,yᵢ)=(pᵢ*S(kᵢ))⊕ (S(pᵢ)*yᵢ)⊕ (kᵢ*S(yᵢ)) (9)

Here ⊕ denotes an XOR of binary strings in Vₙ, being the set of all binary n-strings, and a*b is the multiplication modulo m=2ⁿ−t, for a small odd natural number t (not specified here) of binary n-strings a and b represented as natural numbers.

More specifically an XOR function is applied between the following terms to calculate g₁:
a modular multiplication between the block of plaintext pᵢ and the cyclic shift of the binary representation of kᵢ,
a modular multiplication between the cyclic shift of the binary representation of pᵢ and the block of carrier yᵢ, and
a modular multiplication between the block of a working key kᵢ and the cyclic shift of the binary representation of yᵢ.

More specifically the results of the multiplication, being a natural number in Z/m, that is the set of natural numbers 0, 1, . . . , m−1, is represented again as a binary n-string, and S(x) denotes the cyclic shift of the binary representation of x to one position. That is

(x₀,x₁, . . . , xₙ₋₁)→(x₁, . . . , xₙ₋₁,x₀). (10)

For checking the necessary condition for the encryption-decryption algorithm in FIGS. 3 and 4, y=y₀ and c₀ are fixed and the size of the image of Vₙ is considered under the map

x→y₁=(x*S(x⊕ c₀⊕ y₀))⊕ (S(x)*y₀)⊕ ((x⊕ c₀⊕ y₀)*S(y₀)).

There are no reasons for why it should be much less than the size of Vₙ which is 2ⁿ. The injectivity of a second map is trivial. A third map y→y₁=(x*S(k₀))⊕ (S(x)*y)⊕ (k₀*S(y)) for any fixed x and k₀ also looks close to be injective, with the exception x=k₀=0. But it is very easy to avoid this case in the encryption algorithm.

The function g₁, given by formula (9), is a strong function and it is recommended in cases when the working key represented by blocks kᵢ is the repetition of only one k₀⊕ K₀. That is k=(k₀, k₀, . . . ). But for the working key k=(k₀,k₁, . . . , kₛ_{₀},k₀,k₁, . . . , kₛ_{₀}, . . . )

where s₀>0, a simpler carrier function g₁ can be used. It is preferred to use for the one-way function φ the map

x→((x⊕ y₀)*(x⊕ S⁷(y₀)))⊕ S⁸(x)

and for the carrier function

g₁(x,k₀,y)=(x⊕ S(k₀)⊕ S²(y))*(x⊕ S³(k₀)⊕ S⁵(y))⊕ S⁶(k₀)⊕ S⁴(y)

where Sⁱ is the composition of i shifts given by formula (10). It should be noted that φ is needed in order to produce kᵢ from k₀.

The triangular cipher with such an implantation is hereafter referred to as an additive triangular cipher.

### EXAMPLE 1

Let n=5 and m=31. Then

x=x₀x₁x₂x₃x₄=x₀+x₁2+x₂2²+x₃ 2³+x₄2⁴,

for binary xᵢ. The shift is

x→S(x)

x₀x₁x₂x₃x₄→x₁x₂x₃x₄x₀.

The encryption algorithm as shown in FIG. 3 is

g(pᵢ,kᵢ,yᵢ)=(pᵢ⊕ kᵢ⊕ yᵢ,g₁(pᵢ,kᵢ,yᵢ)),

where formula (10) is the carrier function. The element y₀ is public and may be considered as a part of the cipher.

Put y₀=10101=21. The plaintext p₁,p₂,p₃, . . . is

23,17,12, . . . =11101,10001,00110, . . .

The key sequence k₀, k₁, k₂, k₃, . . . is

15,29,6,13, . . . =11110,10111,01100,10110, . . .

### Encryption:

The sender produces the secret padding code x=p₀=11=11010 and computes

c₀=p₀⊕ k₀⊕ y₀=11⊕ 15⊕ 21=17

because

c₀=11⊕ 15⊕ 21=11010⊕ 11110⊕ 10101=10001=17

bitwise. Then

$$\begin{matrix}{y}_{1} = {g}_{1} ( {p}_{0} , {k}_{0} , {y}_{0} ) \\ = {g}_{1} ( 11 , 15 , 21 ) \\ = ( 11 * S ( 15 ) ) ⊕ ( S ( 11 ) * 21 ) ⊕ ( 15 * S ( 21 ) ) \\ = ( 11 * 23 ) ⊕ ( 21 * 21 ) ⊕ ( 15 * 26 ) \\ = 5 ⊕ 7 ⊕ 18 \\ = 10100 ⊕ 11100 ⊕ 01001 \\ = 00001 \\ = 16 ,\end{matrix}$$

because

S(15)=S(11110)=11101=23,

S(11)=S(11010)=10101=21,

S(21)=S(10101)=01011=26.

At this point the sender discards the secret pad x. Then he computes

c₁=p₁⊕ k₁⊕ y₁=23⊕ 29⊕ 16=26.

and similarly

y₂=g₁(p₁,k₁,y₁)=g₁(23,29,16)=(23*S(29))⊕ (S(23)*16)⊕ (29*S(16))=(23*30)⊕ (27*16)⊕ (29*8)=8⊕ 29⊕ 5=26.

Then

c₂=p₂⊕ k₂⊕ y₂=17⊕ 6⊕ 26=13

and

y₃=g₁(p₂,k₂,y₂)=g₁(17,6,26)=(17*S(6))⊕ (S(17)*26)⊕ (6*S(26))=(17*3)⊕ (24*26)⊕ (6*13)=20⊕ 4⊕ 16=0

Then

c₃=p₃⊕ k₃⊕ y₃=12⊕ 13⊕ 0=1

and

y₄=g₁(p₃,k₃,y₃)=g₁(12,13,0)=(12*S(13))⊕ (S(12)*0)⊕ (13*S(0))=(12*22)=16,

and so on. Finally, the ciphertext c₀,c₁,c₂,c₃, . . . is

17,26,13,1 . . . =10001,01011,10110,10000, . . . .

### Decryption:

The receiver gets the ciphertext c₀,c₁,c₂,c₃, . . . :

17,26,13,1 . . . =10001,01011,10110,10000, . . . .

Said receiver has the working key sequence k₀,k₁,k₂,k₃, . . . :

15,29,6,13, . . . =11110,10111,01100,10110, . . .

and the initial value y₀=10101=21. The receiver computes

p₀=x=c₀⊕ k₀⊕ y₀=17⊕ 15⊕ 21=11

and

y₁=g₁(p₀,k₀,y₀)=g₁(11,15,21)=16

as above. At this point the receiver discards the secret padding code x. Then he computes

p₁=c₁⊕ k₁⊕ y₁=26⊕ 29⊕ 16=23

and

y₂=g₁(p₁,k₁,y₁)=g₁(23,29,16)=26.

Then

p₂=c₂⊕ k₂⊕ y₂=130⊕ 6⊕ 26=17

and

y₃=g₁(p₂,k₂,y₂)=g₁(17,6,26)=0.

Then

p₃=c₃⊕ k₃⊕ y₃=1⊕ 13⊕ 0=12

and

y₄=g₁(p₃,k₃,y₃)=g₁(12,13,0)=16.

The result of this procedure will give the original plaintext.

### EMBODIMENT 2

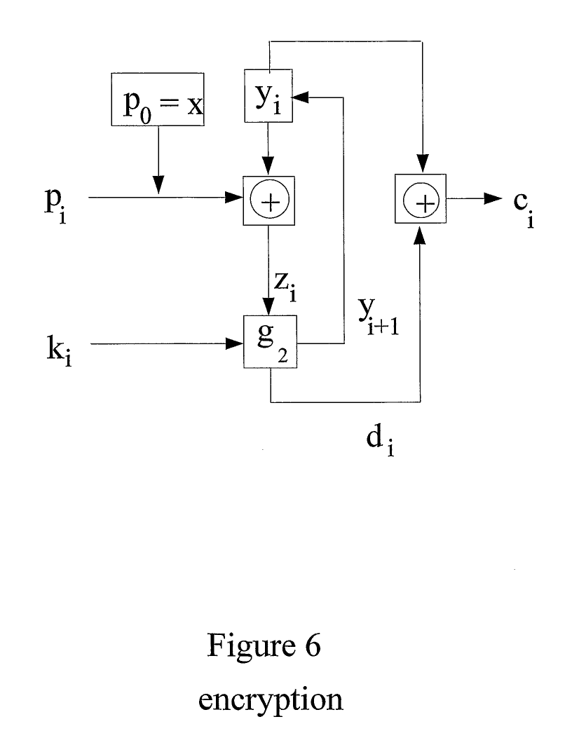

FIG. 6 shows a further exemplary embodiment of the encryption function g of the encryption method described in FIG. 1 of the present invention.

A second pair is defined: X=Y=C₀=Vₙ and K₀=Z*/m, where Z*/m is the set of all nonzero residues modulo m. So

g,h:Vₙ×Z*/m×Vₙ→Vₙ×Vₙ. (11)

To implement the computation g(pᵢ,kᵢ,yᵢ)=(cᵢ,yᵢ₊₁), the function g₂ is considered: g₂:Z*/m×Vₙ→Vₙ×Vₙ so that g₂(kᵢ,zᵢ)=(dᵢ,yᵢ₊₁), where zᵢ=pᵢ⊕ yᵢ, where zᵢ is an intermediate variable. Then, (cᵢ,yᵢ₊₁)=(dᵢ⊕ yᵢ,yᵢ₊₁). The function g₂ is computed by the following rule:

If zᵢεVₙ\Z/m, or in other words zᵢ≧m, then dᵢ=zᵢ and yᵢ₊₁=kᵢ⊕ yᵢ. If zᵢεZ/m, or in other words zᵢ<m, dᵢ,yᵢ₊₁ come from the multiplication of integer numbers kᵢ and zᵢ such that

kᵢzᵢ=dᵢ+yᵢ₊₁m. (12)

In this case, dᵢ,yᵢ₊₁εZ/m are computed with the algorithm:
1. Compute kᵢzᵢ=u₀+u₁2ⁿ, where the integer number u₀ represents the first n bits of the product kᵢzᵢ and u₁ represents the last bits of it.
2. Compute u₀+u₁t=u₀′+u₁′2″, where the integer number u₀′ represents the first n bits of u₀+u₁t and u₁′ represents the last bits of it.
3. Compute v=u₀′+u₁′t and u=u₁+u₁′. If v<m, then dᵢ=v, and yᵢ₊₁=u. If v≧m, then dᵢ=v−m and yᵢ₊₁=u+1.

More specifically, zᵢ equals the XOR of the block of the plaintext pᵢ and the carrier yᵢ, so that if zᵢ≧m, in the representation of zᵢ as a natural number, then dᵢ=zᵢ, and yᵢ₊₁ equals the XOR of the block of the working key kᵢ and the carrier yᵢ, and otherwise the product kᵢzᵢ of representations of kᵢ,zᵢ as natural numbers is computed, where dᵢ and yᵢ₊₁ are the first and second m-adic digits of said product such that kᵢzᵢ=dᵢ+yᵢ₊₁m.

In order to compute dᵢ,yᵢ₊₁ the representation kᵢzᵢ=u₀+u₁2ⁿ is computed, where the natural number u₀ represents n the least significant bits of the product kᵢzᵢ and u₁ represents the last most significant bits of it. Then, u₀+u₁t, where t=2ⁿ−m, is computed and is represented as u₀′+u₁′2ⁿ, where the integer number u₀′ represents n the least significant bits of u₀+u₁t and u₁′ represents the last most significant bits of it. Then, the numbers v=u₀′+u₁′t and u=u₁+u₁′ are computed. If v<m, then dᵢ=v, and yᵢ₊₁=u. If v≧m, then dᵢ=v−m and yᵢ₊₁=u+1. Finally, in both cases, the block of the ciphertext cᵢ is computed as the XOR of dᵢ and yᵢ.

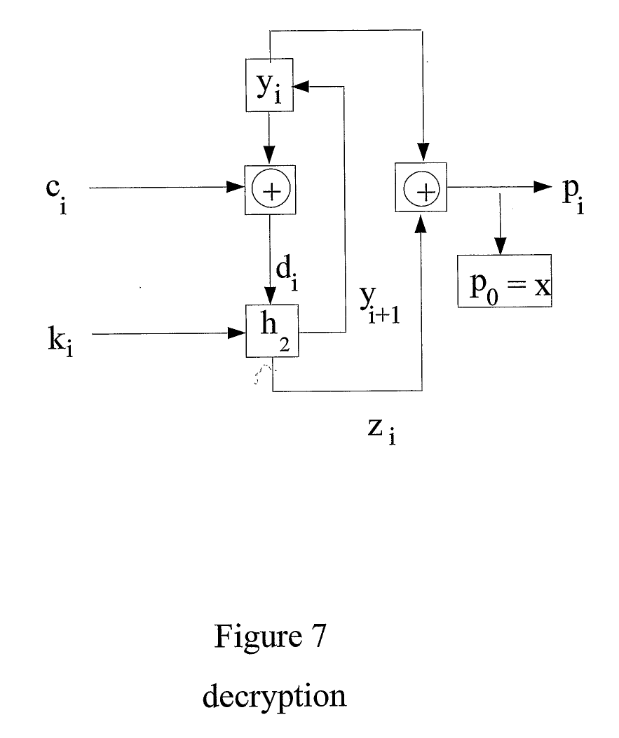

FIG. 7 shows a further exemplary embodiment of the decryption function h of the encryption method described in FIG. 1 of the present invention.

To implement the computation h(cᵢ,kᵢ,yᵢ)=(pᵢ,yᵢ₊₁), the function h₂ is considered: h₂:Z*/m×Vₙ→Vₙ×Vₙ so that h₂(kᵢ,dᵢ)=(zᵢ,yᵢ₊₁), where dᵢ=cᵢ⊕ yᵢ. Then, (pᵢ,yᵢ₊₁)=(zᵢ⊕ yᵢ,yᵢ₊₁). The function h₂ is computed by the rule:

If dᵢεVₙ\Z/m, or in other words dᵢ≧m, then zᵢ=dᵢ and yᵢ₊₁=kᵢ⊕ yᵢ, and if dᵢεZ/m, or in other words dᵢ<m, then zᵢ,yᵢ₊₁ come from formula (12), where kᵢ,dᵢ,m are known, and computed by the following algorithm.

The algorithm uses three auxiliary strings A, B, C of integer numbers, where A=(a₁,a₂,a₃) and B=(b₁,b₂,b₃) are changing during the computation and [a]₀ denotes the least significant bit of a.

A←(0,m−dᵢ), B←(dᵢ,kᵢ,0), C←(m,0,kᵢ)

while a₂>1 do
if a₂<b₂ then A [symbol] B
if [b₂]₀=0 then A [symbol] B

A←(A−[a₂]₀B−([a₁]₀−[a₂]₀[b₁]₀)C)/2

if a₁<0 then A←A+C
return zᵢ←a₁, yᵢ₊₁←a₃

The triangular cipher with such an implantation is hereafter referred to as a multiplicative triangular cipher.

More specifically, h is determined by defining the function h₂(kᵢ,dᵢ)=(zᵢ,yᵢ₊₁), where dᵢ equals the XOR of the block of the ciphertext cᵢ and the carrier yᵢ, so that if dᵢ≧m, in the representation of dᵢ as a natural number, then zᵢ=dᵢ and yᵢ₊₁ equals the XOR of the block of the working key kᵢ and the carrier yᵢ. Otherwise, in order to compute zᵢ and yᵢ₊₁, the four auxiliary 3-strings of integer numbers A, B, C and D are defined, where A, B, D change during computation. The strings are initialized as A=(0,m,−dᵢ), B=(dᵢ,kᵢ,0) and C=(m,0,kᵢ). The following step is repeated until a₂=1, then zᵢ=a₁ and yᵢ₊₁=a₃. Otherwise, if a₂<b₂, then D=A, A=B and B=D is done, and if [b₂]₀=0, then D=A, A=B and B=D. The string D=(A−[a₂]₀B−([a₁]₀−[a₂]₀[b₁]₀)C)/2 is then computed and A=D. After that if a₁<0 then D=A+C and A=D. Finally, in both cases, the block of plaintext pᵢ is computed as the XOR of zᵢ and yᵢ.

The discussion of the necessary conditions for this multiplicative method to be secure is similar to that for the above-mentioned additive triangular cipher.

### EXAMPLE 2

Let n=5 and m=31. The encryption-decryption algorithm is as on FIGS. 4 and 5, that is to compute g(pᵢ,kᵢ,yᵢ)=(cᵢ,yᵢ₊₁).

Let y₀=10101=21, this value is a fixed part of the cipher. The plaintext p₁,p₂,p₃, . . . is

23,17,12, . . .

The key sequence k₀, k₁, k₂, k₃ is

15,29,6,13, . . .

### Encryption:

The sender produces the secret padding code x=p₀=11=11010 and computes

z₀=p₀⊕ y₀=11⊕ 21=30.

Because 30εZ/31, the sender finds the product

k₀z₀=15×30=450=16+14×31,

so (d₀,y₁)=g₂(k₀,z₀)=g₂(15,30)=(16,14) and

c₀=d₀⊕ y₀=16⊕ 21=5.

Then

z₁=p₁⊕ y₁=23⊕ 14=25.

Because 25εZ/31, the sender finds the product

k₁z₁=29×25=725=12+23×31,

so (d₁,y₂)=g₂(29,25) (12,23) and

c₁=d₁⊕ y₁=12⊕ 14=2.

Then

z₂=p₂⊕ y₂=17⊕ 23=6.

Because 6εZ/31, the sender finds the product

k₂z₂=6×6=36=5+1×31

so (d₂,y₃)=g₂(6,6)=(5,1) and

c₂=d₂⊕ y_{2=5⊕ 23=18}

Then

z₃=p₃⊕ y₃=12⊕ 1=13.

Because 13εZ/31, the sender finds the product

k₃z₃=13×13=169=14+5×31,

so (d₃,y₄)=g₂(13,13)=(14,5) and

c₃=d₃⊕ y₃=14⊕ 1=15,

and so on. So the ciphertext c₀,c₁, c₂,c₃, . . . is

5,2,18,15, . . .

### Decryption:

The receiver has the key sequence k₀,k₁,k₂,k₃, . . . :

15,29,6,13, . . .

Then the receiver gets the ciphertext c₀, c₁, c₂,c₃, . . . :

5,2,18,15, . . . .

from the sender.

The receiver computes

d₀=c₀⊕ y₀=5⊕ 21=16

and finds z₀,y₁ from 15z₀=16+y₁31, so (z₀,y₁)=h₂(15,16)=(16,14) and p₀=x=z₀⊕ y₀=30⊕ 21=11. At this point the sender discards x. Then the receiver computes

d₁=c₁⊕ y₁=2⊕ 14=12

and finds z₁,y₂ from 29z₁=12+y₂31, so (z₁,y₂)=h_{2l (}29,12)=(25,23) and p₀=z₁⊕ y₁=25⊕ 4=23. At this point the sender discards x. Then the receiver computes

d₂=c₂⊕ y₂=18⊕ 23=5

and finds z₂,y₃ from 6z₁=5+y₂31, so (z₂,y₃)=h₂(6,5)=(6,1) and p₂=z_{2⊕ y}₂=6⊕ 23=17. Then the receiver computes

d₃=c₃⊕ y₃=15⊕ 1=14

and finds z₃,y₄ from 13z₃=14+y₄31, so (z₃,y₄)=h₂(13,14)=(13,5) and p₃=z₃⊕ y₃=13⊕ 1=12.

1. A method of encrypting digital information in a sender and decrypting said digital information in a receiver, where said sender and receiver agrees on a working key represented by blocks kᵢ, characterized in the following steps:
a) sender generates a secret padding code x,
b) sender combines said digital information with said secret padding code x to produce a padded plaintext represented by blocks pᵢ,
c) sender computes encrypted information represented by blocks cᵢ, by applying a triangular encryption function g,
d) sender transmits said encrypted information cᵢ to said receiver,
e) receiver decrypts said encrypted information cᵢ received from said sender by applying a triangular decryption function h, comprising the inversion of encryption function g, and
f) receiver unpads said digital information by removing said secret padding code x in b) from the blocks of plaintext pᵢ.

2. A method according to claim 1, characterized in that said secret padding code x in a) is generated by a random number generator.

3. A method according to claim 1, characterized in that said secret padding code x in a) is generated by a hash value of a master key and the number of the message the sender is encrypting, or some other information such as time, the receivers name, the receivers address.

4. A method according to claim 1, characterized in that said secret padding code x in a) is generated by a combination of random number generator and a hash value of a master key and the number of the message the sender is encrypting, or some other information such as time, the receivers name, the receivers address.

5. A method according to claim 1, characterized in that said encryption and decryption method c) and e) applies a triangular algorithm comprising both the following functions:
an encryption function g: g(pᵢ,kᵢ,yᵢ)=(cᵢ,yᵢ₊₁), and
a decryption function h: h(cᵢ,kᵢ,yᵢ)=(pᵢ,yᵢ₊₁),
where i=1, 2, 3 . . . , and yᵢ is a sequence of internal states of the cipher before encryption.

6. A method according to claim 5, characterized in that said encryption applies an encryption function g(pᵢ,kᵢ,yᵢ)=(pᵢ⊕ kᵢ⊕ yᵢ,g₁(pᵢ,kᵢ,yᵢ)), where said blocks of ciphertext cᵢ are determined by applying an XOR function between pᵢ, kᵢ and yᵢ bitwise, where i=0, 1, 2, 3 . . . , and the function g, calculates the next internal state yᵢ₊₁ of the cipher.

7. A method according to claim 6, characterized in that said decryption applies a decryption function h(cᵢ,kᵢ,yᵢ)=(cᵢ⊕ kᵢ⊕ yᵢ,g₁(cᵢ⊕ kᵢ⊕ yᵢ,kᵢ,yᵢ)), where said blocks of plaintext pᵢ are determined by applying the an XOR function between cᵢ, kᵢ and yᵢ bitwise.

8. A method according to claim 6 and 7, characterized in that said function g₁ is determined by the following formula:
g₁(pᵢ,kᵢ,yᵢ)=(pᵢ*S(kᵢ))⊕ (S(pᵢ)*yᵢ)⊕ (kᵢ*S(yᵢ)),
that is by applying an XOR function between the following terms:
a modular multiplication between the block of plaintext pᵢ and the cyclic shift of the binary representation of kᵢ,
a modular multiplication between the cyclic shift of the binary representation of pᵢ and the block of carrier yᵢ, and
a modular multiplication between the block of a working key kᵢ and the cyclic shift of the binary representation of yᵢ.

9. A method according to claim 5, characterized in that said encryption function g is determined by defining a function g₂: g₂(kᵢ,zᵢ)=(dᵢ,yᵢ₊₁), where zᵢ=pᵢ⊕ yᵢ, (cᵢ,yᵢ₊₁)=(dᵢ⊕ yᵢ,yᵢ₊₁), and g₂ is determined by defining the following:
a) dᵢ=zᵢ and yᵢ₊₁=kᵢ⊕ yᵢ if zᵢ≧m, where zᵢ is an intermediate variable, and m is a prime number,
b) kᵢzᵢ=dᵢ+yᵢ₊₁m if zᵢ<m,
and dᵢ,yᵢ₊₁ are computed with the following algorithm:
1. Implementation of computation of kᵢzᵢ=u₀+u₁2ⁿ, where the integer number u₀ represents the first n bits of the product kᵢzᵢ and u₁ represents the last bits of it,
2. Implementation of computation of u₀+u₁t=u₀′+u₁′2ⁿ, where the integer number u₀′ represents the first n bits of u₀+u₁t and u₁′ represents the last bits of it,
3. Implementation of computation of v=u₀′+u₁′t and u=u₁+u₁′. If v<nm, then dᵢ=v, and yᵢ₊₁=u. If v≧m, then dᵢ=v−m and yᵢ₊₁=u+1.

10. A method according to claim 9, characterized in that said decryption function h is determined by defining a function h₂: h₂(kᵢ,dᵢ)=(zᵢ,yᵢ₊₁), where dᵢ=cᵢ⊕ yᵢ, (pᵢ,yᵢ₊₁)=(zᵢ⊕ yᵢ,yᵢ₊₁), and h₂ is determined by defining the following:
a) zᵢ=dᵢ and yᵢ₊₁=kᵢ⊕ yᵢ if dᵢ≧m, and
b) kᵢzᵢ=dᵢ+yᵢ₊₁m if dᵢ<m,
where zᵢ,yᵢ₊₁ are computed by the following algorithm:
A←(0,m,−dᵢ), B←(dᵢ,kᵢ,0), C←(m,0,kᵢ),
while a₂>1 do
if a₂<b₂ then A [symbol] B
if [b₂]₀=0 then A [symbol] B
A←(A−[a₂]₀B−([a₁]₀−[a₂]₀[b₁]₀)C)/2
if a₁<0 then A←A+C
return zᵢ←a₁, yᵢ₊₁←a₃,
where A, B, C are three auxiliary strings of integer numbers, and A and B change during the computation, and [a]₀ denotes the least significant bit of a.
